(19) United States
(12) Patent Application Publication
(10) Pub. No.: US 2021/0013504 A1
(43) Pub. Date: Jan. 14, 2021

(54) MANGANESE OXIDE CONTAINING MATERIAL FOR ELECTRODES AND ELECTROCHEMICAL DEVICES USING THE ELECTRODES

(71) Applicant: Sparkle Power LLC, Rochester, NY (US)

(72) Inventor: David Mitlin, Lakeway, TX (US)

(21) Appl. No.: 16/924,766

(22) Filed: Jul. 9, 2020

Related U.S. Application Data
(60) Provisional application No. 62/871,885, filed on Jul. 9, 2019.

(51) Int. Cl. H01M 4/50; H01M 4/36; H01M 4/38; H01M 4/583; H01M 6/04

(52) U.S. Cl. CPC H01M 4/50; H01M 4/362; H01M 2004/021; H01M 4/583; H01M 6/045; H01M 4/38

(57) ABSTRACT

A material for use as an electrode in an electrochemical storage device, the material including: a composite including at least one manganese oxide and at least one ion-active carbon. An electrode for an electrochemical storage device and an electrochemical storage device is also disclosed.

### CROSS-REFERENCE TO RELATED APPLICATIONS

The instant application claims priority to co-pending U.S. Provisional Application No. 62/871,885, filed on Jul. 9, 2019, and entitled “Manganese Oxide-Porous Carbons with Ultra Low Self Discharge and Ultra High Density Derived from Hemp and Cannabis for Energy Storage”. The entirety of the aforementioned provisional application is incorporated by reference in its entirety.

### FIELD OF THE INVENTION

The present invention relates to electrodes for electrochemical storage devices, and more particularly to a material for use as an electrode for an electrochemical storage device, the material including manganese oxide and a carbon material.

### BACKGROUND OF THE INVENTION

Nanostructuring of manganese oxide electrodes is normally necessary to allow for fast Li ion diffusion and facile lithiation-delithiation kinetics. Without nanostructuring, manganese oxide-based electrodes are very slow to charge-discharge and are therefore not useful.

Nanostructuring involves making the manganese oxide nanoparticles and nanocrystallines and creating nanoposity within the electrode. Nanostructuring intrinsically results high surface area (e.g. >100 m²) electrodes.

The surface area of nanostructured manganese oxide is higher than that of graphite, which is the commercially established anode material. However, high surface area anodes intrinsically suffer from poor initial and cycling Coulombic efficiency (CE), consuming electrolyte and building up a thick solid electrolyte interphase (SEI) layer. Both phenomena lead to rapid cycling-induced failure as well as secondary safety concerns. Therefore, there is a tradeoff between fast kinetics and electrode instability, both being caused by nanostructuring. This tradeoff prevents nanostructured manganese oxide electrodes from being employed in commercial LIB anode applications.

What is desired is a material for an electrode that can be employed which addresses safety concerns, does not demonstrate rapid cycling-induced failure, does not demonstrate or suffer from poor initial and cycling CE, has reduced electrolyte consumption, and reduced build up of SEI. The embodiments disclosed herein are believed to address one or more of the aforementioned concerns.

### SUMMARY

Manganese oxide based on MnₓO_{y} with and without alloying elements-based anodes are promising for lithium ion battery (LIB) applications. For simplicity, these stoichiometric, substoichiometric and alloy oxides are termed to as “MnO” and “MnO-carbon” (or “MnO—SPC”) with the understanding that the oxide compositions are potentially more complex. MnO and MnO—SPC offer sloping voltage profiles, offer resistance to Li metal plating and to dendrite growth, which are considered safety risks.

One aspect of the invention is directed to a material for use as an electrode in an electrochemical storage device, the material comprising: composite including at least one manganese oxide and at least one ion-active carbon. In one embodiment, the composite includes one or more alloying elements including silicon, germanium, antimony, tin, graphite, vanadium, or combinations thereof. In one embodiment, the one or more alloying elements are substantially continuously distributed throughout the composite. In another embodiment, the one or more alloying elements are discontinuously distributed. In one embodiment, the material has a surface area between about 1 and about 50 m²/g. In one embodiment, the ion-active carbon is derived from a fibrous plant material, wood, a forestry product, a petroleum product coal, or an agricultural product. In one embodiment, the ratio of manganese oxide to ion-active carbon is about 1:10 to about 10:1 by weight. In one embodiment, the composition has a structure composed substantially of micro-scale features.

One aspect of the invention is directed to an electrochemical storage device, comprising: a cathode, an anode, and an electrolyte in communication with the cathode and the anode, wherein the anode includes a composite including at least one manganese oxide and at least one ion-active carbon. In one embodiment, the composite includes one or more alloying elements including silicon, germanium, antimony, tin, graphite, vanadium, or combinations thereof. In one embodiment, the one or more alloying elements are substantially continuously distributed throughout the composite. In another embodiment, the one or more alloying elements are discontinuously distributed. In one embodiment, the material has a surface area between about 1 and about 50 m²/g. In one embodiment, the ion-active carbon is derived from a fibrous plant material, wood, a forestry product, a petroleum product coal, or an agricultural product. In one embodiment, the ratio of manganese oxide to ion-active carbon is about 1:10 to about 10:1 by weight. In one embodiment of the device, the anode includes a plurality of microstructures composed of the composite. In one embodiment of the device, the anode further comprises a carbon coating.

In another aspect, the present invention is directed to an electrode for an energy storage device comprising the aforementioned material. In one embodiment of the electrode, the composite includes one or more alloying elements including silicon, germanium, antimony, tin, graphite, vanadium, or combinations thereof; and the ion-active carbon includes: a mean particle size between 1-40 microns; a BET surface area between 750-3500 m²/g; and a pore size distribution being at least one of microporosity, mesoporosity, and macroporosity, wherein the carbon material is derived from a natural precursor or synthetic precursor. In one embodiment, the electrode further comprises a carbon coating.

### BRIEF DESCRIPTION OF THE DRAWINGS

FIG. 1 is a schematic illustration of a material for an electrode of an electrochemical storage device in accordance with an embodiment disclosed herein.

FIGS. 2 (a) and 2(b) are schematic illustrations of an electrochemical storage device in accordance with an embodiment disclosed herein. FIG. 2(a) is a schematic illustration of the outside of the electrochemical storage device, while FIG. 2(b) is a schematic illustration of an electrochemical storage device and the inside contents thereof.

FIGS. 3(a)-(f) are transmission electron microscopy (TEM) images of certain embodiments the ion active carbon disclosed herein. FIGS. 3(a) and 3(b) are TEM images of hemp pyrolyzed at 800° C., FIGS. 3(c) and 3(d) are TEM images of hemp pyrolyzed at 1000° C., and FIGS. 3(e) and 3(f) are TEM images of hemp pyrolyzed at 1200° C. FIGS. 3(a), 3(c) and 3(e) show low magnification images of dense carbons. FIGS. 3(b), 3(d) and 3(f) show high magnification images illustrating complete absence of graphene ordering and pores.

FIG. 4 is a scanning electron microscope image of a material including MnO and an ion-active carbon.

### DETAILED DESCRIPTION OF THE INVENTION

In one aspect, the present invention overcomes at least the above-mentioned problems by combining manganese oxide (MnO) with an ion-active carbon (also referred to herein as “Li-active carbon”, or “SPC”, or “SPC carbons”) that provides a complementary solid-state diffusional path for the ions. The inventor has surprisingly found that the ion-active carbons act as an “Ion Highway” facilitating rapid charging and discharging of the electrodes despite their non-nanoscale size.

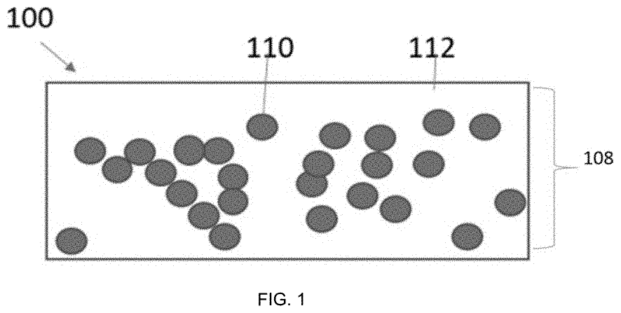

In a particular aspect, the present invention provides a material for use as an electrode in an electrochemical storage device. FIG. 1 provides a schematic illustration of a material 100. The schematic illustration is provided for purposes of discussion only and is not meant to limit the size, shape, overall nature, dimensions, and/or surfaces of the material 100.

In one embodiment, the material 100 is used as an electrode in an electrochemical storage device, for example, as a cathode or as an anode. The material 100 can be used as a standalone electrode. In another embodiment, the material is combined with a secondary material (not shown). Examples of secondary materials include, but are not limited to activated carbon, graphene, graphite, horse hair, pyrolyzed horse hair, carbon black, soot, ceramic particles, oxide particles, nitride particles, sulfide particles, metallic particles such as Cu. In another embodiment, the material 100 is used as an additive to boost the performance of a primary energy storage material that is an oxide such as MnxOy, NiO, PbxOy, BixOy, VxOy where x and y are any values between 0 and 1.

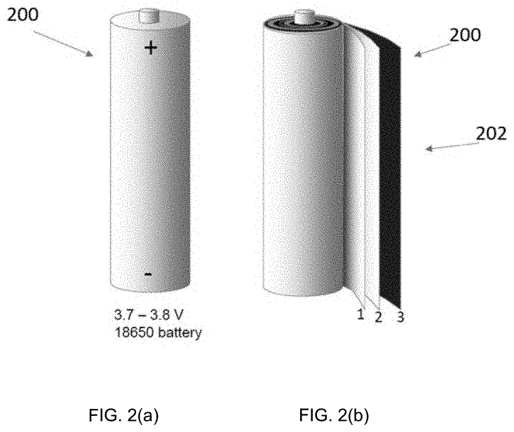

An example of an electrochemical storage device is shown in FIGS. 2(a) and 2(b) and is labeled as reference numeral 200. Examples of electrochemical storage devices 200 include, but are not limited to, batteries, capacitors, supercapacitors, ultracapacitors, symmetric capacitors, hybrid capacitors, and the like. FIGS. 2 (a) and 2(b) illustrate an 3.7-3.8V, 18650 battery, however the invention is not limited in this regard as any type or style of battery is contemplated. In a particular embodiment, the electrochemical storage device 200 is an aqueous battery, and in particular an aqueous lithium ion battery. In one example, an aqueous lithium-ion (Li-ion) battery is a lithium-ion battery that uses a concentrated saline solution as an electrolyte to facilitate the transfer of lithium ions between electrodes and induce an electrical current. In another embodiment, the electrochemical storage device 200 is an aqueous zinc ion battery. In one example, an aqueous zinc ion battery uses Zn(CF₃SO₃)₂ as the electrolyte.

As shown in FIG. 2(b), the electrochemical storage device 200 includes, in an interior portion 202, at least one electrode. In the embodiment shown in FIG. 2(b), the device 100 includes a cathode 1, an anode 3, and a separator 2, which are submerged in an electrolyte (not labeled). Separator 2 and the electrolyte are generally known in the art and known separators and electrolytes are acceptable to use in the device 200.

In one embodiment, the electrolyte is an organic electrolyte or an aqueous electrolyte. In one embodiment, the electrolyte is an organic electrolyte that includes 1.0 M tetraethylammonium tetrafluoroborate (TEATFB) salt in acetonitrile (ACN) solvent. In another embodiment, the electrolyte is a concentrated saline solution. In another embodiment, the electrolyte is Zn(CF₃SO₃)₂. Other known electrolytes can be used in connection with the device 200.

It is contemplated that in one embodiment of the device 200, the anode 3 includes the material 100 described herein. However, the invention is not limited in this regard as the cathode 1 may also include the material 100 described herein. In one embodiment, the device 200 is a lithium ion battery (LIB) and the cathode 1 is a slurry of cathode material (e.g. NCA, NMC, LiFePO₄, sulfur) with binder and carbon additive on a current collector and the anode 3 is a material 100 according to an embodiment described herein.

Turning back to FIG. 1, the material 100 includes a composite designated with reference numeral 108. As used herein, the term “composite” means an article or material that is made from two or more constituent materials, i.e., made from two or more components, wherein the constituent materials typically have different physical and/or chemical properties. The constituent materials work together to provide the overall composite with unique properties. In the instant invention, the composite facilitates rapid charging and discharging of electrodes despite their non-nanoscale size, reduction in electrolyte consumption, reduction in build up of SEI, and have improved initial and cycling CE as compared to known electrode materials.

The composite 108 includes at least one manganese oxide (MnO) 110 and at least one ion-active carbon 112. The material 100 including MnO and at least one ion-active carbon 112 is not in nanoscale and is therefore distinct from established manganese oxide nanocomposites, nanostructured particulates, nanosheets, nanorods, and other nanoscale structures.

In one embodiment, the composite 108 of the material 100 includes MnO 110, the ion-active carbon 112, and one or more alloying elements (not shown). The alloying elements include silicon, germanium, antimony, tin, graphite, vanadium, and combinations thereof. In this embodiment, where alloying elements are present, the chemical formula of the manganese oxide is MnₓO_{y}A_{z}, where A is the alloying element. In a particular embodiment, silicon (Si) is employed as the alloying element. Silicon further boosts solid state diffusivity, in a ratio MnₓO_{y}Si_{z}, with x, y, z being between 0 and 1. The material 100 including MnO, the alloying element(s), and at least one ion-active carbon 112 is not in nanoscale and is therefore distinct from established manganese oxide nanocomposites, nanostructured particulates, nanosheets, nanorods, and other nanoscale structures.

It is contemplated that in one embodiment, the alloying elements form a continuous distributed network within the MnO in the composite 108. That is, in one embodiment, the one or more alloying elements are substantially continuously distributed throughout the composite 108. For instance, at least 51% of the composite 108 has MnO with alloying element(s) continuously distributed. In another embodiment, at least 60% of the composite 108 has MnO with alloying element(s) continuously distributed. In another embodiment, at least 70%, at least 75%, at least 80%, at least 85%, at least 90%, or at least 95% of the composite 108 has MnO with alloying elements continuously distributed. In one embodiment, 100% of the composite 108 has MnO with alloying elements continuously distributed throughout.

In another embodiment, the alloying elements forms a discontinuous distributed network within the composite 108. That is, the one or more alloying elements are discontinuously distributed. In this embodiment, there is no continuity or equal distribution of the MnO with alloying elements.

The material 100 having the composite 108 including MnO 110, and ion-active carbon 112, may be microparticulate or microplates, possessing a low surface area. In one embodiment, the material 100 has a surface area between about 1 and about 50 m²/g. The material 100 having the composite 108 including MnO 110, and ion-active carbon 112, and alloying elements may be microparticulate or microplates, possessing a low surface area, between about 1 and about 50 m²/g.

Since standalone electrodes made from this material 100 are contemplated, the electrodes have the same characteristics and properties of the material 100.

In one embodiment, the ion-active carbon 112 is a carbon that is derived from a fibrous plant material, wood, a forestry product, a petroleum product coal, or an agricultural product. In one embodiment, the ion-active carbon 112 is derived from hemp fiber. In another particular embodiment, the ion-active carbon 112 is derived from cannabis. It is contemplated that a mixture of precursors can be used to form the ion-active carbon 112.

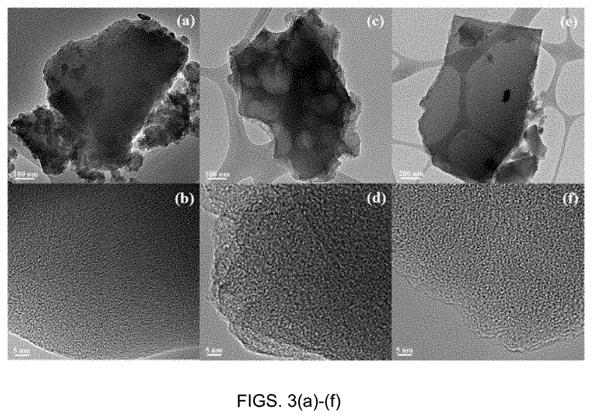

In particular, hemp fiber is used as a precursor for the ion-active carbon and the ion-active carbon is synthesized by physical and/or chemical activation of the hemp fiber, including one or a combination of phosphoric acid, steam, nitrogen, potassium hydroxide, sodium hydroxide, carbon dioxide, hydrogen and other reactive gases. The synthesis process also may include a washing treatment before and or after the activation process. FIG. 3(a)-3(f) illustrates transmission electron microscope (TEM) images of ion-active carbons derived from hemp and pyrolyzed at three different temperatures: 800° C., 1000° C. and 1200° C. The hemp derived ion-active carbon does not have graphene ordering and does not have pores. FIGS. 3(b), 3(d) and 3(f) confirm the absence of pores of hemp derived ion-active carbons pyrolyzed at 800° C., 1000° C., 1200° C. and 1400° C.

The BET surface area of the hemp-derived ion-active carbons pyrolyzed at 800° C., 1000° C., 1200° C. and 1400° C. is between 7-99 m2/g. The DFT surface area of hemp derived ion-active carbons pyrolyzed and activated is between 419-2259 m2/g. The pore volumes for hemp derived ion-active carbons pyrolyzed and activated at 800° C., 1000° C. and 1200° C. are 0.260-1.085 cm3/g.

The ion-active carbons, and in particular ion-active carbons derived from a fibrous plant material, wood, a forestry product, or an agricultural product can be activated by any known activation process or technique, including, but not limited to, physical activation (e.g., oxidizing gases such as air, O₂, CO₂, steam, mixtures thereof, or heat, for a certain amount of time) or chemical activation (e.g., with KOH, NaOH, H₃PO₄, ZnCl₂, etc.). It is contemplated that a combination of both physical and chemical processes can be used for activation. Physical activation is typically a two-step process, where pyrolysis of the precursor is performed prior to activation. Chemical activation is typically a one step process where the activating agent is incorporated into the carbon precursor prior to pyrolysis.

Ion-active carbons possess unique physical, chemical and textural (density, porosity, pore size distribution) properties. These properties lead to exceptional electrochemical energy storage performance.

One embodiment of the ion-active carbon has the following properties: Mean particle size of 2-20 microns; total BET surface area of 1000-3500 m\hat{ }2/g; pore size distribution: High volume fraction of small mesopores. For example, 50% of the total pore volume is 2-4 nm wide. The other 50% of the total volume is 1-2 nm. Maximum 0 content <7 wt. %, ideally <4%, even more ideally <3%. Maximum metal and inorganic content in the ppm range.

In one embodiment of the material 100, the ratio of manganese oxide to ion-active carbon is about 1:10 to about 10:1 by weight.

In one embodiment, the composite 108 has a structure composed substantially of micro-scale features. The term “micro-scale” as used herein refers to the size between 0.1 micrometers to 100 micrometers, which is larger than the aforementioned nanoscale structures, which have a size between 1 nanometer to 100 nanometers. In general, the morphology of composite 108 is not nanoscale, and is preferably free of nanoscale features. The composite 108 does not possess nanopores or nanovoid external or internal spaces. It will be understood that since an electrode is made from the material 100 that includes the composite 108, the electrode itself is then composed of micro-scale features and has the aforementioned characteristics.

As noted above, the material 100 can be used as a stand-alone electrode. In one embodiment, the material 100 can be used as an anode 3. In one embodiment, the material 100 can be used as a cathode 1. In another embodiment, the material 100 is present in an electrochemical storage device 200 as an anode 3 and a cathode 1. In one embodiment, the material can be used as a cathode 1 opposing a metal anode, including, for example, Li, Na, Zn, and K anodes.

Electrochemical capacitors (aka ultracapacitors, supercapacitors) having electrodes fabricated with ion-active carbon possess excellent volumetric capacitance values of ˜45 F/cc and good specific capacitance values of ˜50 F/g. These capacitance values translate into high capacity and high energy for battery and hybrid ion device applications.

Electrodes made from material 100 have a density of about −0.94 g/cm3, which is higher than electrodes made from commercially available supercapacitor carbon, YP-50 carbon. High density is important for volume limited energy storage applications.

In one embodiment of the electrode, the electrode that includes material 100 further includes a carbon coating (also referred to as a “secondary carbon”). The carbon coating can be any known carbon material. The carbon coating has a low surface area. The carbon coating is used as a host to create a low-surface area 3D microcomposite. This embodiment is similarly generally free of nanoscale features like open or closed pores, with a surface area on-par with graphite. This allows for high packing density manganese oxide particles that offer fast charge—discharge kinetics but avoid SEI—related problems associated with high surface area nanomaterials.

It is further contemplated that the material 100 further includes other ion active and inactive materials such as mixed oxides including carbon black, silicon and its alloys, tin and its alloys, antimony and its alloys, sulfur and its alloys, ceramic ion intercalation compounds, graphite, graphene, activated carbon, hard carbon, soft carbon, titanium oxides and its alloys, sulfides, nitrides and selenides.

### EXAMPLES

I. Synthesis of Material including MnO and Ion-Active Carbon

To make a material 100 including a composite 108 of MnO 110 and ion-active carbon 112, the desired precursor, e.g., hemp fiber, was activated and pyrolyzed to form the carbon. The carbon was dried at 65° C. for 1 hour and then mixed at high-shear with a polytetrafluoroethylene (PTFE, commercially available as Teflon™) binder at 3.0% by weight. MnO is added to the carbon to form a MnO-carbon composite. The ratio of MnO to carbon can be 1:0 through 0:1 by weight or 10:1 through 1:10 by weight, or any ratio there between, with the preferable range between 1:10 to 10:1. The MnO-carbon composite material (i.e., electrodes) were dried under vacuum conditions (mechanical roughing pump) in a special container at 195° C. for 15 hours.

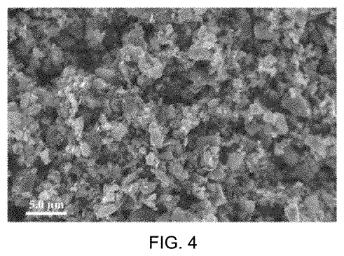

Scanning electron microscope (SEM) images of the MnO-carbon composite shows a composite with a dense, low surface area and a microscale morphology. This is shown in FIG. 4.

The MnO-carbon composite can be formed into sheets. The sheets can be punched into discs. Alternatively, the sheets can be used as a standalone anode in a battery, e.g., a lithium ion battery.

II. Galvanostatic Charge-Discharge Profiles, Rate Performance Data, and Cyclability Data

Galvanostatic charge-discharge profiles of MnO-carbon composite as electrode as compared to a commercially available prior art electrode including graphite were generated. Testing was done at 93 mA g-1 and performed Li/Li+. The material of the present invention, i.e., the MnO-composite, displayed much higher reversible charge storage capacity as compared to the commercially available electrodes (500 mAh/g vs. 300 mAh/g).

Rate performance data and cyclability data for MnO-carbon composites compared to commercially available electrodes that include graphite illustrate that the MnO-carbon composites of the present invention is improved as compared to the commercially available electrode.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A material for use as an electrode in an electrochemical storage device, the material comprising:
a composite including at least one manganese oxide and at least one ion-active carbon.

2. The material according to claim 1, wherein the composite includes one or more alloying elements including silicon, germanium, antimony, tin, graphite, vanadium, or combinations thereof.

3. The material according to claim 2, wherein the one or more alloying elements are substantially continuously distributed throughout the composite.

4. The material according to claim 2, wherein the one or more alloying elements are discontinuously distributed.

5. The material according to claim 1, wherein material has a surface area between about 1 and about 50 m²/g.

6. The material according to claim 1, wherein the ion-active carbon is derived from a fibrous plant material, wood, a forestry product, a petroleum product coal, or an agricultural product.

7. The material according to claim 1, wherein the ratio of manganese oxide to ion-active carbon is about 1:10 to about 10:1 by weight.

8. The material according to claim 1, wherein the composite has a structure composed substantially of micro-scale features.

9. An electrochemical storage device, comprising:
a cathode, an anode, and an electrolyte in communication with the cathode and the anode,
wherein the anode includes a composite including at least one manganese oxide and at least one ion-active carbon.

10. The device according to claim 9, wherein the composite includes one or more alloying elements including silicon, germanium, antimony, tin, graphite, vanadium, or combinations thereof.

11. The device according to claim 10, wherein the one or more alloying elements are substantially continuously distributed throughout the composite.

12. The device according to claim 10, wherein the one or more alloying elements are discontinuously distributed.

13. The device according to claim 9, wherein the material has a surface area between about 1 and about 50 m²/g.

14. The device according to claim 9, wherein the ion-active carbon is derived from a fibrous plant material, wood, a forestry product, a petroleum product coal, or an agricultural product.

15. The device according to claim 9, wherein the ratio of manganese oxide to ion-active carbon is about 1:10 to about 10:1 by weight.

16. The device according to claim 9, wherein the anode includes a plurality of microstructures composed of the composite.

17. The device according to claim 9, wherein the anode further comprises a carbon coating.

18. An electrode for an electrochemical storage device according to claim 1.

19. The electrode according to claim 18, wherein
the composite includes one or more alloying elements including silicon, germanium, antimony, tin, graphite, vanadium, or combinations thereof; and
wherein the ion-active carbon includes:
a mean particle size between 1-40 microns;
a BET surface area between 750-3500 m²/g; and
a pore size distribution being at least one of microporosity, mesoporosity, and macroporosity, wherein the carbon material is derived from a natural precursor or synthetic precursor.

20. The electrode according to claim 18, wherein the electrode further comprises a carbon coating.
